(19) United States
(12) Patent Application Publication
(10) Pub. No.: US 2006/0028183 A1
(43) Pub. Date: Feb. 9, 2006

(54) Battery device of vehicle power supply

(76) Inventors: Ryosaku Izawa, Higashiosaka-city (JP); Naoki Tsuzurano, Ohta-city (JP)

Correspondence Address: WENDEROTH, LIND & PONACK, L.L.P., 2033 K STREET N. W., SUITE 800, WASHINGTON, DC, 20006-1021, US

(21) Appl. No.: 11/187,931

(22) Filed: Jul. 25, 2005

(30) Foreign Application Priority Data
Jul. 23, 2004 (JP) 215967/2004

(51) Int. Cl. H02J 7/04

(52) U.S. Cl. 320/150

(57) ABSTRACT

A power device for a vehicle includes a plurality of batteries, a case accommodating the batteries, a blower for forcibly supplying air to the batteries accommodated in the case, thereby cooling them, and a temperature sensor for coming in contact with a surface of the battery to detect a temperature of the battery. A thermal portion for detecting the temperature of the battery of the temperature sensor includes a thermal element to be thermally coupled to the surface of the battery, and a heat insulating material having a cushioning property to be elastically compressed which serves to thermally insulate the thermal element provided on the surface of the battery from the cooling air, and the thermal element is isolated from the cooling air supplied forcibly by means of the heat insulating material having the cushioning property, thereby detecting the temperature of the battery.

### BACKGROUND OF THE INVENTION

1. Field of the Invention

The present invention mainly relates to a power device for a large current which is to be used for a power supply of a motor for driving an automobile such as a hybrid car or an electric car.

2. Description of the Related Art

An automobile such as an electric car for running by means of a motor or a hybrid car for running by means of both a motor and an engine mounts a power device accommodating a battery in a case. The power device causes the automobile to run by means of a motor. In order to increase an output, therefore, a large number of batteries are connected in series, thereby raising an output voltage and increasing the driving current of the motor. When a vehicle is to be braked, moreover, the power device is charged by regenerative braking. The regenerative braking rotates a generator by means of wheels to brake the vehicle. Therefore, the kinetic energy of the vehicle can be stored effectively in a battery. The braking force of the regenerative brake is increased in proportion to the output of the generator. For this reason, the battery is charged with a large current when sudden braking is carried out. Furthermore, the braking is continuously applied when going down along a slope. For this reason, a charging current flows continuously to the battery, and is increased when braking is strongly applied. As described above, the power device for a vehicle is charged with a large current, and is discharged with the large current and is accelerated by the motor when a sudden acceleration is applied.

In the power device for a vehicle, the battery is charged/discharged with a large current. In some cases, therefore, the temperature of the battery is raised. When the battery is charged/discharged in a state in which the temperature is raised, a lifetime is shortened. The power device for a vehicle is very expensive because a large number of great batteries are connected. For this reason, it is Important that the lifetime is to be prolonged. In order to prevent a deterioration from being caused by the temperature of the batter, the temperature of the battery is detected, and a charging/discharging current is controlled to be limited or cut off when the temperature of the battery is raised. Thus, the bad effect is prevented.

In order to detect the temperature of the battery, there has been developed a power device for thermally coupling a temperature sensor to the surface of the battery.

### SUMMARY OF THE INVENTION

In a power device described in the publication, a temperature sensor formed by a PTC is fixed to the surface of a battery. In the temperature sensor formed by the PTC, an electric resistance is rapidly increased to detect a temperature abnormality when the temperature of the battery is raised extraordinarily. For example, there is used a PTC for rapidly increasing the electric resistance when the temperature of the battery is raised to 80□. The battery fixing the temperature sensor to a surface is coupled rectilinearly and the surface is coated with a thermal shrinking tube to form a battery module. The battery module is insulated with the thermal shrinking tube on the surface.

The aforementioned structure has a drawback that it is hard for the temperature sensor to detect the temperature of the battery with high precision. The reason is that a temperature detected by the temperature sensor is influenced by the temperature and amount of cooling air for cooling the battery. The power device for a vehicle operates a blower to forcibly cool the battery when the temperature of the battery is raised. The cooling air supplied from the blower cools the battery from a surface, and furthermore, cools the temperature sensor forcibly. In particular, the temperature sensor is small in order to quickly detect a rise in the temperature of the battery. For this reason, when forcible cooling is carried out on an outside, the detected temperature is rapidly lowered.

The drawback that the temperature sensor is forcibly cooled with the cooling air can be lessened by fixing the temperature sensor to the surface of the battery and applying a silicone resin or the like to a surface thereof, for example. With this structure, however, a great deal of time an labor is required for putting the battery in a case to be assembled. When a maintenance is to be carried out, moreover, the temperature sensor cannot easily be removed from the surface of the battery. When a silicone resin bonded to the surface of the battery is peeled, furthermore, the cooling air enters a clearance so that the detected temperature becomes inaccurate. For this reason, it is very difficult for the temperature sensor to accurately detect the temperature of the battery with high precision by use for a long period of time in an environment in which the temperature is greatly changed.

The present invention has been developed in order to solve the aforementioned drawbacks. An important object of the present invention is to provide a power device for a vehicle which can simply and easily dispose a temperature sensor to be thermally coupled to the surface of a battery in a preferable condition and can detect the temperature of the battery by means of the temperature sensor with very high precision. Moreover, another important object of the present invention is to provide a power device for a vehicle which can accurately detect the temperature of a battery by means of a temperature sensor for a long period of time and can easily carry out an assembly and a maintenance.

The power device for a vehicle according to the present invention comprises a plurality of batteries 6, a case 2 accommodating the batteries 6, a blower 3 for forcibly supplying air to the batteries 6 accommodated in the case 2, thereby cooling them, and a temperature sensor 4 for coming in contact with a surface of the battery 6 to detect a temperature of the battery 6. A thermal portion 4A for detecting the temperature of the battery of the temperature sensor 4 includes a thermal element 10 to be thermally coupled to the surface of the battery 6, and a heat insulating material 12 having a cushioning property to be elastically compressed which serves to thermally insulate the thermal element 10 provided on the surface of the battery 6 from the cooling air, and the thermal element 10 is isolated from the cooling air supplied forcibly by means of the heat insulating material 12 having the cushioning property, thereby detecting the temperature of the battery 6.

The power device for a vehicle described above has a feature that the temperature sensor is disposed simply and easily to be thermally coupled to the surface of the battery in a preferable condition and the temperature of the battery can be detected by means of the temperature sensor with very high precision. The reason is as follows. The thermal element is provided in such a manner that the temperature sensor is thermally coupled to the surface of the battery, and the thermal element is insulated from the cooling air of the battery with a heat insulating material having a cushioning property which is elastically compressed and the thermal element is isolated from the cooling air supplied forcibly to detect the temperature of the battery by means of the heat insulating material having the cushioning property. In particular, the cushioning property to be compressed elastically can give an elastic deformation to stick to the surface of the battery without a clearance and can effectively hinder the cooling air from cooling the thermal element. Therefore, there is a feature that the temperature of the battery can be detected accurately also in a state in which the air is forcibly supplied to the battery to carry out cooling.

Moreover, the power device described above also has a feature that the temperature of the battery can accurately be detected by means of the temperature sensor for a long period of time. The reason is that the thermal element can be reliably isolated from the cooling air by means of the heat insulating material having the cushioning properly to be compressed elastically. Furthermore, the power device described above also has a feature that an assembly and a maintenance can be carried out easily. The reason is that the power device isolates the thermal element from the cooling air through the heat insulating material having the cushioning property to be compressed elastically, thereby implementing the detection of the temperature of the battery with high precision. The heat insulating material having the cushioning property to be elastically compressed is pressed against the surface and is elastically deformed to adhere to the surface of the battery and does not need to be applied without a clearance differently from a silicone resin. In the power device described above, the thermal element is provided on the surface of the battery, and is covered with the heat insulating material and can be thus isolated from the cooling air. Therefore, it is possible to carry out an assembly very easily.

In the power device for a vehicle according to the present invention, the heat insulating material 12 having the cushioning property to be compressed elastically can be a soft synthetic resin foam.

In the power device for a vehicle according to the present invention, the case 2 can be provided with the batteries 6 in a mutual approaching and parallel posture, the thermal portion 4A can be interposed between the batteries 6, the heat insulating material 12 having the cushioning property to be compressed elastically can be deformed elastically to cause both surfaces of the thermal portion 4A to elastically adhere to an opposed surface of the battery 6 by means of the heat insulating material 12.

The power device described above has a feature that the thermal portion can be inserted in the battery to detect the temperature of the battery in an ideal condition. The reason is as follows. The thermal portion of the temperature sensor is inserted between the batteries to approach each other to interpose the thermal portion between the batteries. Therefore, the heat insulating material having the cushioning property to be elastically compressed is deformed elastically to elastically press the thermal element to approach the surface of the battery and both surfaces of the heat insulating material stick to the surface of the battery without a clearance.

In the power device for a vehicle according to the present invention, the thermal portion 4A of the temperature sensor 4 can be coupled to a holder case 8 through an elastic arm 13, and the elastic arm 13 can elastically press the thermal portion 4A toward the surface of the battery 6 and can thermally couple them.

In the power device described above, the thermal portion of the temperature sensor is elastically pressed against the surface of the battery by means of the elastic arm. Therefore, it is possible to elastically deform the heat insulating material, thereby sticking to the surface of the battery without a clearance. For this reason, the heat insulating material blocks the cooling of the thermal element by the cooling air in a more ideal condition. Accordingly, the thermal element detects the temperature of the battery with very high precision.

In the power device for a vehicle according to the present invention, the thermal portion 4A of the temperature sensor 4 can include a heat absorbing metal plate 11 to be thermally coupled to the surface of the battery 6. In the temperature sensor 4, the heat absorbing metal plate 11 can fix the thermal element 10 to a surface in a larger external shape than the thermal element 10, and an opposed surface to be thermally coupled to the surface of the battery 6 can be thermally insulated by means of the heat insulating material 12.

In the power device described above, the thermal element is fixed to the heat absorbing metal plate, thereby absorbing the temperature of the battery by means of the heat absorbing metal plate efficiently. Therefore, it is possible to quickly detect the temperature of the battery by means of the thermal portion with high precision.

In the power device for a vehicle according to the present invention, the elastic arm 13 can elastically press the thermal portion 4A against the surface of the battery through the heat insulating material 12.

In the power device for a vehicle according to the present invention, the thermal portion 4A of the temperature sensor 4 can fix the thermal element 10 to an opposed surface to the battery 6 of the heat absorbing metal plate 11, thereby insulating the opposed surface thermally by the heat insulating material 12.

In the power device for a vehicle according to the present invention, the thermal portion 4A of the temperature sensor 4 can be covered with a film 14.

The above and further objects and features of the invention will be more fully apparent from the following detailed description with accompanying drawings.

### BRIEF DESCRIPTION OF THE DRAWINGS

FIG. 1 is a schematic view showing a state in which a power device for a vehicle according to an example of the present invention is mounted on the vehicle,

FIG. 2 is a schematic sectional view showing the power device for a vehicle according to the example of the present invention,

FIG. 3 is an exploded perspective view showing the power device for a vehicle according to the example of the present invention,

FIG. 4 is a perspective view showing a battery module provided in the power device Illustrated in FIG. 3,

FIG. 5 is an enlarged perspective view showing a temperature sensor illustrated in FIG. 4, and

FIG. 6 is an enlarged sectional view showing a state in which the temperature sensor is provided between batteries.

### DETAILED DESCRIPTION OF THE PREFERRED EMBODIMENTS

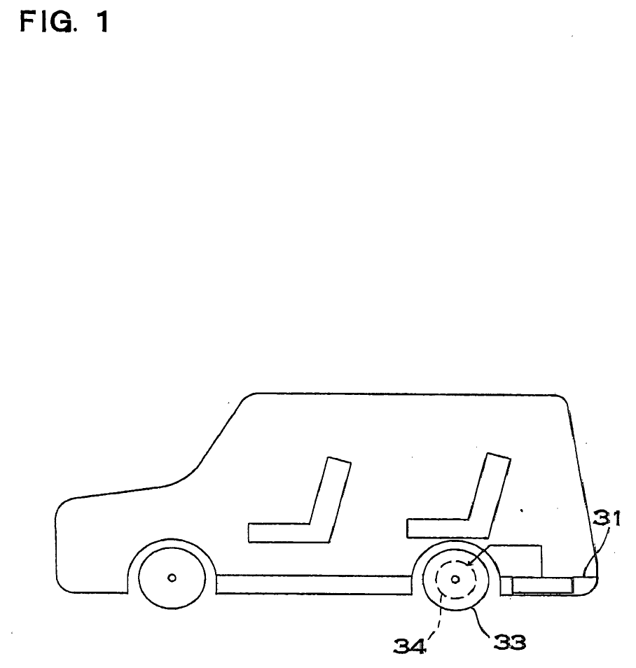

As shown in FIG. 1, a power device for a vehicle is mounted on the vehicle such as an electric car or a hybrid car. The power device is mounted on a floor panel 31 of the vehicle. A position in which the power device is to be mounted is not specified for the floor panel of the vehicle. The power device supplies a power to a motor 34 for driving a wheel 33, thereby causing the vehicle to run. The power supplied from the power device to the motor 34 is controlled by a control circuit (not shown) mounted on the vehicle. Moreover, the charge of the power device is also controlled by the control circuit. The power device of the electric car is charged by a regenerative brake when breaking is applied. The power device of the hybrid car is charged by both the regenerative brake and a generator which is mounted.

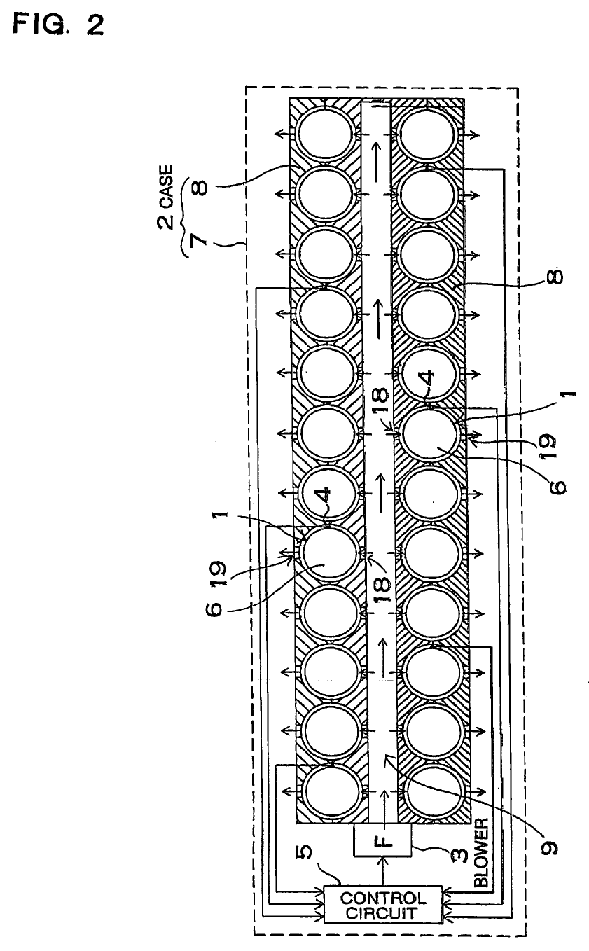

FIG. 2 is a schematic sectional view showing the power device. The power device in FIG. 2 comprises a plurality of batteries 6, a case 2 accommodating the batteries 6, a blower 3 for forcibly supplying air to the batteries 6 accommodated in the case 2 and cooling them, a temperature sensor 4 coupled thermally to the surface of the battery and serving to detect the temperature of the battery, and a control circuit 5 for controlling the operation of the blower 3 and the charge/discharge of the battery 6 by means of the temperature sensor 4.

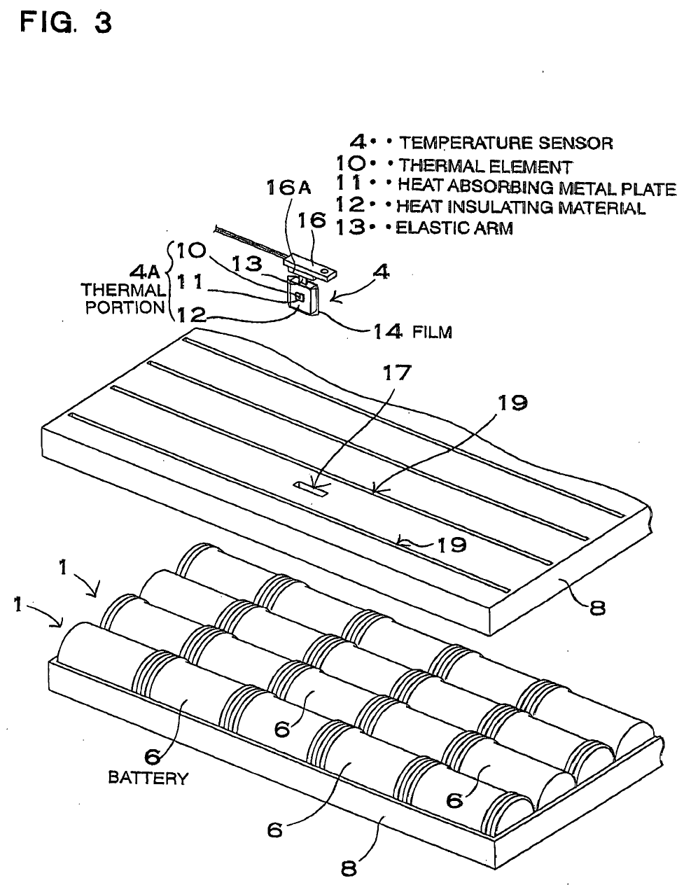

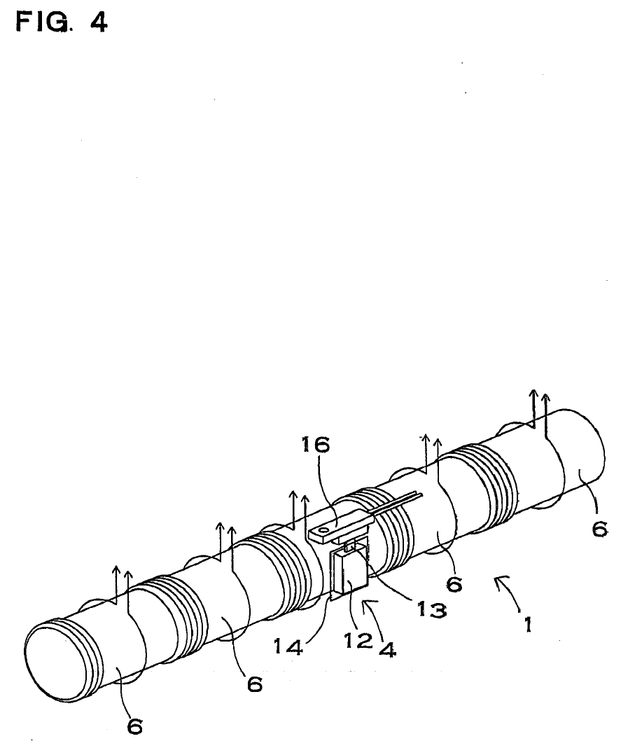

The battery 6 is accommodated in the case 2 in the state of a battery module 1. In the power device shown in FIG. 2, the battery module 1 is arranged in a horizontal plane and is provided in two upper and lower stages. In the battery module 1, a plurality of secondary batteries 6 is connected in series and is coupled rectilinearly. In the battery module 1 shown in FIGS. 3 and 4, five batteries 6 are connected in series and are coupled rectilinearly. In the battery module, however, four to eight, preferably five or six secondary batteries are connected in series and are coupled rectilinearly. The battery module can also be constituted by one secondary battery. In the battery module 1, the secondary battery 8 of a cylindrical type or a square type is coupled rectilinearly through the connecting member of a metal plate or without the connecting member with the end faces of the batteries connected directly in series. An electrode terminal including a positive electrode terminal and a negative electrode terminal is coupled to both ends of the battery module 1. The electrode terminal screws a bus bar (not shown) of the metal plate, thereby coupling the adjacent battery modules 1 in series or in parallel.

The secondary battery 6 of the battery module 1 is a nickel-hydrogen battery. For the secondary battery of the battery module, it is also possible to use a nickel-cadmium battery, a lithium ion secondary battery or the like.

In the power device shown in FIG. 2, the case 2 has a double structure including an outer case 7 and a holder case 8 accommodated in the outer case 7. The outer case 7 is a tough metal case and the holder case 8 is a plastic case for holding and accommodating the battery 6 in a certain position. The case 2 having this structure has a feature that the battery 6 can be insulated through the plastic case and can be accommodated in the tough outer case 7. In the power device according to the present invention, the case does not need to have the double structure but may have a tough triple structure or more which is formed by only a tough plastic or formed by a metal plate and a plastic.

The holder case 8 has a structure in which the battery 6 to be held in the certain position is cooled by the air supplied from the blower 3. In the holder case 8 shown in FIG. 2, an inflow duct 9 is provided between the upper and lower battery modules 1 provided in the two upper and lower stages, and the blower 3 is coupled to the inflow duct 9. The air in the inflow duct 9 passes through an inflow port 18 and a discharge port 19 which are provided in the holder case 8, and is fluidized over the surface of the battery module 1 to forcibly cool the battery 6 as shown in an arrow of FIG. 4.

The outer case 7 fixes and accommodates the holder case 8 in a certain position, and includes the blower 3 for forcibly supplying air to the holder case 8 and the control circuit 5 for controlling the operation of the blower 3. The blower 3 is controlled by the control circuit 5 and is operated when the temperature of the battery is higher than a set temperature. When the blower 3 is operated, the cooling air is supplied to the holder case 8 to forcibly cool the battery module 1. When the temperature of the battery module 1 is lower than the set temperature, the control circuit 5 stops the operation of the blower 3. Moreover, the control circuit 5 detects the temperature of the battery 6 and also controls charge/discharge. For example, when the temperature of the battery is higher than the set temperature, a charging/discharging current is limited or cut off. Furthermore, the control circuit 5 outputs, to a vehicle side, a signal indicating that the temperature of the battery is raised, and information indicating that the charge/discharge of the battery 6 is limited or stopped is output to the vehicle side. The control circuit 5 detects the temperature of the battery through the temperature sensor 4.

The temperature sensor 4 comes in contact in the battery 6 to detect the temperature of the battery. The temperature sensor 4 detects the temperature of the specific battery 6 in the specific battery module 1. The temperature sensor 4 does not need to detect the temperatures of all the batteries 6. For example, in the power device in which a large number of battery modules 1 are provided horizontally as shown in FIG. 2, the temperature of the battery is detected in four to ten places. In the power device, the battery 6 can be charged/discharged and can be cooled while increasing the number of measuring points at which the temperature of the battery is detected by the temperature sensor 4 to accurately control the temperature. When the number of the measuring points is increased, the control circuit 5 is complicated so that a manufacturing cost is increased, and furthermore, a breakdown is also caused more often. For this reason, the measuring point of the temperature sensor 4 is set to have an optimum value in consideration of the number and array of the battery modules 1.

Furthermore, the power device is provided with two temperature detecting circuits. Consequently, a more ideal temperature control can be implemented. A first temperature detecting circuit uses a thermistor for a thermal element and a second temperature detecting circuit uses a PTC for the thermal element. The thermistor can accurately detect the temperature of the battery. However, the control circuit becomes complicated. In the PTC, an electric resistance is rapidly increased when a detected temperature reaches a set temperature. By connecting all of the PTCs in series, it is possible to detect that any of the temperatures of the batteries reaches a set temperature. Therefore, it is possible to simplify the whole structure of the circuit. Accordingly, the temperature of the specific battery is detected by the first temperature detecting circuit using the thermistor as the thermal element to control the charge/discharge of the battery and the operation of the blower, and all of the temperatures of the batteries are detected by the second temperature detecting circuit using the PTC as the thermal element, and a processing of blocking the charge/discharge or the like can be carried out to charge/discharge the battery under the control of an ideal temperature when the temperature of any battery is extraordinarily raised.

More specifically, the first temperature detecting circuit for accurately detecting the temperature of the battery accurately detects the temperature of a specific battery, and the temperatures of all of the batteries are detected by the second temperature detecting circuit capable of simplifying the structure of the circuit. Consequently, it is possible to implement an Ideal temperature control. In the power device according to the present invention, the temperature sensor to be used in the temperature detecting circuit using the thermal element as the thermistor is set to have the following peculiar structure and the second temperature detecting circuit is set to have a conventional structure so that an ideal temperature control can be implemented. More specifically the first and second temperature detecting circuits are provided to detect the temperature of the battery, and the first temperature detecting circuit is set to have the following structure, thereby implementing the ideal temperature control. It is apparent that the temperature sensor of the second temperature detecting circuit also has the following structure in the power device according to the present invention. The second temperature detecting circuit uses, for the thermal element, the PTC in place of the thermistor.

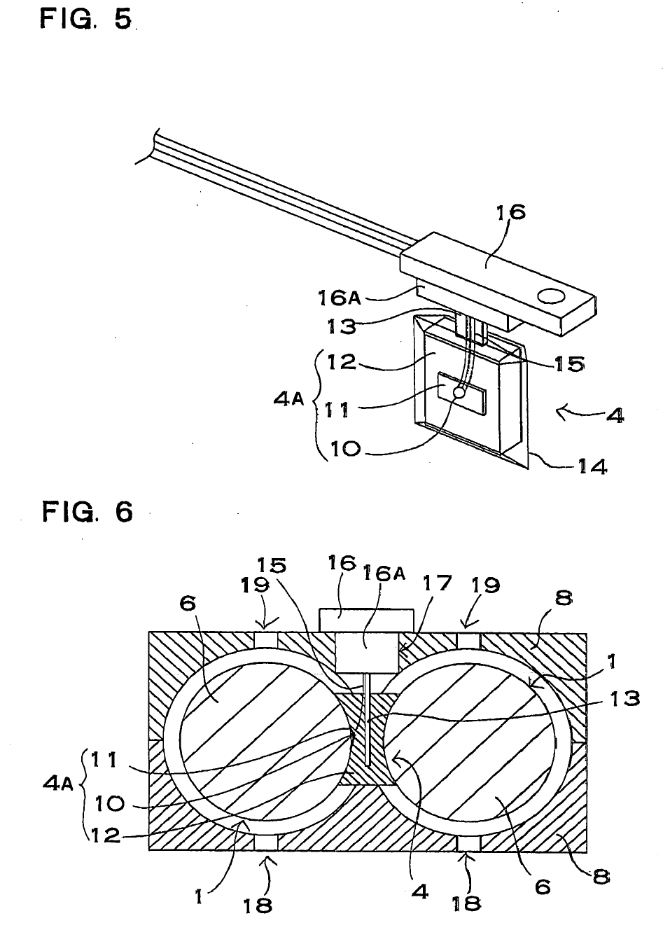

The temperature sensor having a peculiar structure which is provided in the power device according to the example of the present invention will be described below in detail. The temperature sensor 4 shown in FIGS. 5 and 6 comprises a thermal element 10 for converting the temperature of the battery 6 into an electric resistance, a heat absorbing metal plate 11 having a surface to which the thermal element 10 is fixed, a heat insulating material 12 provided on the back of the heat absorbing metal plate 11, an elastic arm 13 for pressing the thermal element 10 toward the surface of the battery 6, and a film 14 for covering the surfaces of the heat absorbing metal plate 11 and the heat insulating material 12 which are laminated.

The thermal element 10 is a thermistor. The thermistor changes an electric resistance at the temperature of the battery, thereby detecting the temperature of the battery. The thermal element 10 can use an element for changing an electric resistance at the temperature of a varistor or a PTC in place of the thermistor. Moreover, it is also possible to use an element having a characteristic changed depending on a temperature as in a transistor or an FET. The thermal element 10 is fixed to the opposed surface of the heat absorbing metal plate 11 to the battery 6 and directly comes in contact with the surface of the battery 6. The thermal element 10 has a surface provided with a thermal conductor having a high thermal conductivity so that the thermal conductor can also be caused to come in contact with the surface of the battery 6. The thermal element 10 detects the temperature of the battery quickly. The thermal element 10 is fixed to the back face of the heat absorbing metal plate 11 so that the temperature of the battery 6 can also be detected through the heat absorbing metal plate 11. A pair of lead wires 15 connected to the thermal element 10 is insulated and passes through the inside of the heat insulating material 12, and is led out of the case 2 along the elastic arm 13.

The heat absorbing metal plate 11 serves to effectively absorb the heat of the battery 6. The heat absorbing metal plate 11 is formed of aluminum or copper which has a high thermal conductivity. The heat absorbing metal plate 11 has a thickness of 0.3 mm or less, preferably 0.2 mm or less. The metal plate having a thickness which is less than 0.3 mm is curved along the surface of the cylindrical-shaped battery 6 so that a contact area with the battery 6 can be increased. In particular, the temperature sensor 4 for laminating, on a back face, the heat insulating material 12 having a cushioning property to be elastically compressed presses the heat absorbing metal plate 11 against the surface of the battery by means of the heat insulating material 12 to deform the heat absorbing metal plate 11 into a shape conforming to the surface of the battery so that the heat absorbing metal plate 11 can come in contact with the battery 6 in a large area. The heat absorbing metal plate 11 has a larger external shape than the thermal element 10 and has a contact area with the battery 6 which is larger than the thermal element 10, thereby increasing precision in the detection of the temperature. Moreover, the thermal element 10 is quickly heated by the heat of the battery 6, thereby reducing the delay of a detection time. The heat absorbing metal plate 11 comes in contact with the surface of the battery 6 in a larger area than the thermal element 10 or approaches the surface of the battery and is thermally coupled so that the temperature of the thermal element 10 is raised by the heat of the battery 6 quickly and efficiently. In the temperature sensor 4 including the heat absorbing metal plate 11, the heat absorbing metal plate 11 efficiently absorbs the heat of the battery 6 in a large area, thereby raising the temperature of the thermal element 10 quickly. In order for the thermal element 10 to detect the temperature, it is necessary to raise the temperature of the thermal element 10 itself by the battery 6, that is, to raise the temperature by the heat of the battery 6. In other words, this implies that the thermal element 10 absorbs the heat of the battery 6. The battery 6 quickly raises the temperature of the thermal element 10 and the thermal element 10 accurately detects the temperature of the battery 6 depending on the efficiency of the conduction of the heat of the battery 6 to the thermal element 10. In the temperature sensor 4 provided with the heat absorbing metal plate 11, the heat absorbing metal plate 11 absorbs the heat of the battery 6 in a large area to heat the small thermal element 10. Therefore, the heat of the battery 6 can be quickly transferred to the thermal element 10. In order to implement the transfer, the heat absorbing metal plate 11 is to come in contact with the battery 6 in a larger area than the contact of the thermal element 10 with the battery 6. For this reason, the heat absorbing metal plate 11 is set to be larger than the thermal element 10. While the temperature sensor 4 including the heat absorbing metal plate 11 can detect the temperature of the battery accurately and quickly, the power device according to the present invention does not need to provide the heat absorbing metal plate in the temperature sensor. The reason is that the thermal element can be heated by the heat of the battery, thereby detecting the temperature of the battery

The heat insulating material 12 has a cushioning property which thermally insulates the thermal element 10 from the cooling air and is elastically compressed in order to prevent the thermal element 10 from being cooled by the cooling air. The heat insulating material 12 has the cushioning property to be elastically compressed for the following reason. More specifically, the surfaces of the thermal element 10 and the heat absorbing metal plate 11 are to be completely covered in a state in which the heat insulating material 12 adheres to the surface of the battery 6, and the cooling air is to be thus prevented from directly coming in contact with the thermal element 10 and the heat absorbing metal plate 11. An ideal material for the heat insulating material 12 is a soft synthetic resin foam, for example, a soft urethane foam. For the heat insulating material, it is also possible to use a soft synthetic resin foam other than the soft urethane foam, for example, an EVA foam, a vinyl chloride foam and the like.

Moreover, the heat insulating material 12 having the cushioning property to be elastically compressed has a further excellent feature. The feature is that the temperature of the battery can be detected more accurately in a state in which the heat insulating material 12 is interposed between the batteries 6 as shown in FIG. 6. In the power device, the batteries 6 are provided in the case 2 in a mutual approaching and parallel posture as shown in FIG. 6. When the temperature sensor 4 is inserted between the batteries 6 in this array, the temperature sensor 4 is interposed between the adjacent batteries 6. Since the batteries 6 interpose the temperature sensor 4 therebetween, the heat insulating material 12 having the cushioning property to be elastically compressed is elastically pressed against an opposed surface to the battery 6 deformed elastically to carry out the interposition and adheres thereto. In this condition, the heat absorbing metal plate 11 and the thermal element 10 are pressed against the surface of the battery 6, thereby detecting the temperature accurately. In the temperature sensor 4 adhering to the surface of the battery 6 in this condition, a thickness in the non-compression state of the heat insulating material 12 is set to be greater than the minimum interval between the adjacent batteries 6. It is preferable that the thickness of a portion provided with the heat absorbing metal plate 11 should be set to be greater than the interval between the batteries with which this portion comes in contact.

In the temperature sensor 4 shown in FIG. 6, the external shape of the heat insulating material 12 is set to be greater than that of the thermal element 10 and is set to be further greater than that of the heat absorbing metal plate 11. In the temperature sensor 4, the heat insulating material 12 completely covers the back face of the heat absorbing metal plate 11, that is, an opposed surface to be thermally coupled to the surface of the battery, thereby carrying out a heat insulation. Consequently, the thermal element 10 and the heat absorbing metal plate 11 can be prevented from being cooled with the cooling air. In the temperature sensor having no heat absorbing metal plate, the heat insulating material covers an opposed side to an opposed surface to the battery of the thermal element, thereby insulating the same side from the cooling air thermally.

The elastic arm 13 couples the thermal element 10 of the temperature sensor 4 to the holder case 8, thereby pressing the thermal element 10 elastically toward the surface of the battery 6 and thermally coupling the thermal element 10. In the temperature sensor 4 shown in FIGS. 5 and 6, the elastic arm 13 has a lower end coupled to the heat insulating material 12 and an upper end fixed to a mount 16. The elastic arm 13 is a metal plate which can be deformed elastically. When the mount 16 is fixed to the holder case 8, the elastic arm 13 provides the heat absorbing metal plate 11 and the thermal element 10 in an opposed position to the surface of the battery 6 and elastically presses them against the surface of the battery 6. The elastic arm 13 in FIG. 6 has such a length as to position the heat absorbing metal plate 11 and the thermal element 10 between the adjacent batteries 6.

The film 14 covers a thermal portion 4A constituted by the heat absorbing metal plate 11 and the heat insulating material 12 which fix the thermal element 10. The film 14 is a plastic film 14 having a high thermal conductivity and such a flexibility as to be freely deformed together with the heat insulating material 12 having the cushioning property, and having such a strength as to freely protect the thermal portion 4A to be accommodated therein. The film 14 covers the whole surface of the thermal portion 4A. The film 14 puts the thermal portion 4A between two plastic films and thermally welds or bonds them around the thermal portion 4A, and accommodates the thermal portion 4A therein.

In the temperature sensor 4 having the structure described above, the mount 16 is fixed to the holder case 8 and the thermal portion 4A is provided between the batteries 6. The holder case 8 is provided to penetrate through a fixing hole 17 for the temperature sensor 4 as shown in FIG. 3. The fixing hole 17 has such a size and shape as to freely insert through the thermal portion 4A of the temperature sensor 4 and to freely fit a fitting portion 16A provided on the lower surface of the mount 16. The thermal portion 4A is inserted through the fixing hole 17 and the fitting portion 16A provided on the lower surface of the mount 16 is fitted so that the temperature sensor 4 is fixed to the holder case 8. In this state, the thermal portion 4A of the temperature sensor 4 is provided in a certain position. The mount 16 is fixed to the holder case 8 with a screw.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims. This application is based on Application No. 2004-215,967 filed in Japan on Jul. 23, 2004, the content of which is incorporated hereinto by reference.

What is claimed is:

1. A power device for a vehicle comprising:
a plurality of batteries;
a case accommodating the batteries;
a blower for forcibly supplying air to the batteries accommodated in the case, thereby cooling them; and
a temperature sensor for coming in contact with a surface of the battery to detect a temperature of the battery,
wherein a thermal portion for detecting the temperature of the battery of the temperature sensor includes a thermal element to be thermally coupled to the surface of the battery, and a heat insulating material having a cushioning property to be elastically compressed which serves to thermally insulate the thermal element provided on the surface of the battery from the cooling air, and the thermal element is isolated from the cooling air supplied forcibly by means of the heat insulating material having the cushioning property, thereby detecting the temperature of the battery.

2. The power device for a vehicle according to claim 1, wherein the heat insulating material having the cushioning property to be compressed elastically is a soft synthetic resin foam.

3. The power device for a vehicle according to claim 1, wherein the case is provided with the batteries in a mutual approaching and parallel posture, the thermal portion is interposed between the batteries, the heat insulating material having the cushioning property to be compressed elastically is deformed elastically to cause both surfaces of the thermal portion to elastically adhere to an opposed surface of the battery by means of the heat insulating material.

4. The power device for a vehicle according to claim 1, wherein the thermal portion of the temperature sensor is coupled to a holder case through an elastic arm, and the elastic arm elastically presses the thermal portion toward the surface of the battery and thermally couples them.

5. The power device for a vehicle according to claim 1, wherein the thermal portion of the temperature sensor includes a heat absorbing metal plate to be thermally coupled to the surface of the battery, and the heat absorbing metal plate fixes the thermal element to a surface in a larger external shape than the thermal element, and an opposed surface to be thermally coupled to the surface of the battery is thermally insulated by means of the heat insulating material.

6. The power device for a vehicle according to claim 5, wherein the external shape of the heat insulating material is larger than that of the heat absorbing metal plate.

7. The power device for a vehicle according to claim 4, wherein the elastic arm elastically presses the thermal portion against the surface of the battery through the heat insulating material.

8. The power device for a vehicle according to claim 5, wherein the thermal portion of the temperature sensor fixes the thermal element to an opposed surface to the battery of the heat absorbing metal plate, thereby insulating the opposed surface thermally by the heat insulating material.

9. The power device for a vehicle according to claim 1, wherein the thermal portion of the temperature sensor is covered with a film.

10. The power device for a vehicle according to claim 1, wherein an operation of the blower is controlled by the temperature sensor.

11. The power device for a vehicle according to claim 1, wherein charge/discharge of the battery is controlled by the temperature sensor.

12. The power device for a vehicle according to claim 1, wherein the temperature sensor detects a temperature of a battery module having a plurality of secondary batteries connected in series.

13. The power device for a vehicle according to claim 1, further comprising two temperature detecting circuits, a thermal element of a first temperature detecting circuit being a thermistor and a thermal element of a second temperature detecting circuit being a PTC.

14. The power device for a vehicle according to claim 13, wherein an operation of the blower is,controlled by the first temperature detecting circuit.

15. The power device for a vehicle according to claim 13, wherein charge/discharge of the battery is blocked by the second temperature detecting circuit.
